(19) United States
(12) Patent Application Publication
(10) Pub. No.: US 2018/0073573 A1
(43) Pub. Date: Mar. 15, 2018

(54) CLUTCH

(71) Applicant: BATOM CO., LTD., Taichung City (TW)

(72) Inventor: Norman Lien, Taipei City (TW)

(21) Appl. No.: 15/696,173

(22) Filed: Sep. 5, 2017

(30) Foreign Application Priority Data
Sep. 10, 2016 (TW) 105129499

(51) Int. Cl. F16D 23/14; F16D 13/52; F16D 13/64; F16D 13/75; F16D 28/00

(52) U.S. Cl. CPC F16D 23/14; F16D 13/52; F16D 28/00; F16D 13/75; F16D 13/648

(57) ABSTRACT

A reliable mechanical clutch is disclosed. The clutch includes a clutch assembly and an engagement assembly together selectively coupling or decoupling driving and driven members. The gist of the present invention lies in grooves of end-to-end gradually reduced depth are formed on interfacing faces between active and passive rings where balls are accommodated to roll. The active and passive rings, when turned, would be close to or away from each other, thereby causing the clutch assembly to function. The clutch is therefore structurally simple, has a low failure rate, and may effectively reduce its form factor and production cost. Its function is purely through mechanical operation with limited triggering force but produce a powerful push, thereby achieving greater reliability.

### BACKGROUND OF THE INVENTION

### (a) Technical Field of the Invention

The present invention generally relates to clutches, and particularly to a mechanical clutch of enhanced structure and reliability.

### (b) Description of the Prior Art

Generally a clutch is configured between a driving member and a driven member for selective engagement, speed change, or brake. Usually a clutch includes a clutch assembly and an engagement assembly. The clutch assembly includes a number of discs connecting to the driving member and a number of discs connecting to the driven member stacked together. The engagement assembly couples or separates these discs so as to achieve the selective engagement, speed change, or brake. The engagement assembly may be classified into one of the following categories.

The electromagnetic clutch has an electromagnetic valve in front of the clutch assembly. The electromagnetic valve is powered by electrical energy to perform linear reciprocal motion to selectively couple the discs of the clutch assembly together. Electrical components and wires are therefore configured inside the clutch, leading to complex structure and greater form factor. In addition, electromagnetic force provides limited coupling strength, malfunctions are frequent, and the manufacturing and assembly costs are high.

The hydraulic clutch has a hydraulic driving mechanism inside the clutch to perform reciprocal motion to selectively couple the discs of the clutch assembly together. Hydraulic fluid channels have to be configured inside the clutch, and therefore this clutch has a delicate and complex structure. There are also compression ratio and qualitative change issues to the hydraulic fluid, thereby compromising the stability of the hydraulic pressure. High pressure is often avoided so as to avoid leaking problem, and the exerted coupling force is less than adequate. The hydraulic clutch therefore also suffers high failure rate and high cost.

As described above, both electromagnetic and hydraulic clutches provide limited coupling force, leading to inferior reliability. Their structures are also complex and production costs are high. Furthermore, these clutches cannot be modularized and their maintenance or replacement is difficult and time-consuming.

### SUMMARY OF THE INVENTION

Therefore a major objective of the present invention is to provide a clutch of high reliability whose coupling of the clutch assembly is achieved through fast and direct mechanical driving.

Another major objective of the present invention is to provide a modularized clutch so that its maintenance and replacement is significantly simplified and convenient.

Yet another major objective of the present invention is to provide a clutch of simplified structure, low failure rate, reduced form factor, and low production code.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a clutch according to an embodiment of the present invention.

FIG. 2 is a perspective break-down diagram showing the various components of the clutch of FIG. 1.

FIG. 3 is a schematic sectional diagram showing the clutch of FIG. 1.

FIG. 4 is another schematic sectional diagram showing the clutch of FIG. 1.

FIG. 5 is a schematic sectional diagram showing the operation of the clutch of FIG. 1.

FIG. 6 is another schematic sectional diagram showing the modular replacement of the clutch of FIG. 1.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

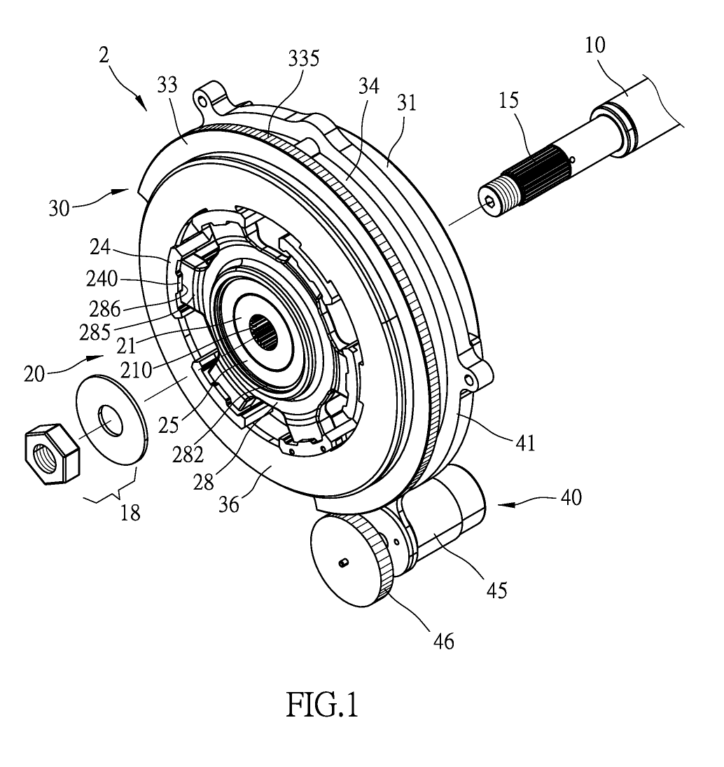

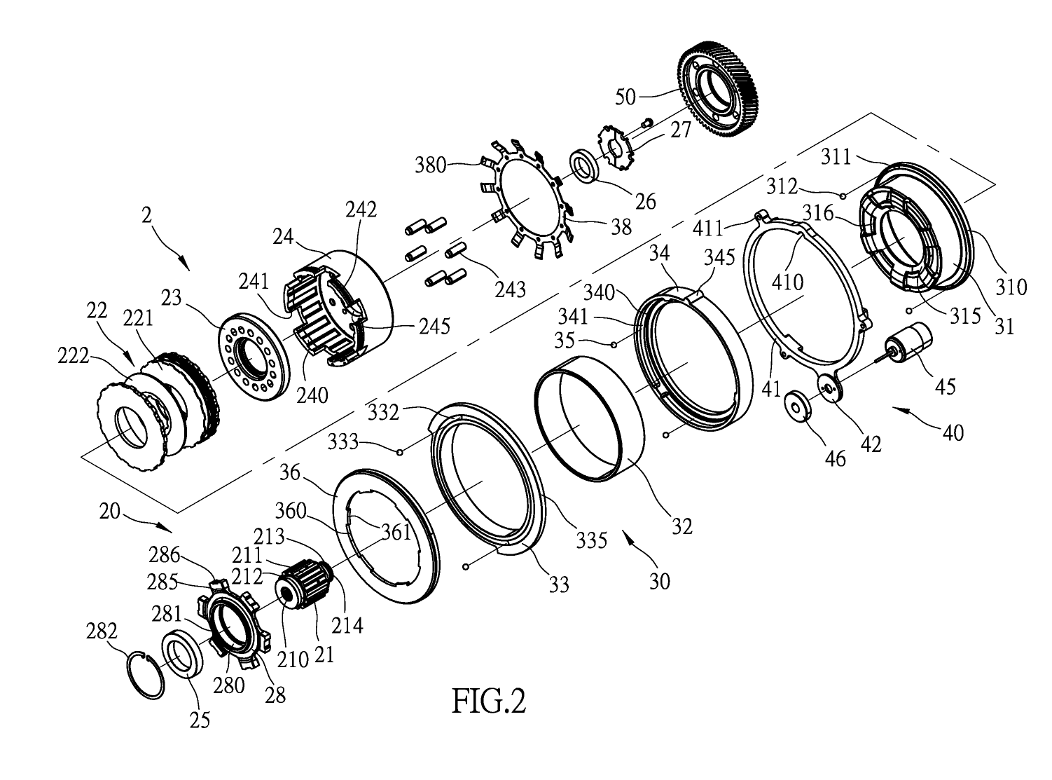

As shown in FIGS. 1 and 2, a clutch 2 according to an embodiment of the present invention is configured between a driving member 10 and a driven member 50 so that the driving member 10 may selectively engage or disengage the driven member 50. The clutch 2 includes a clutch assembly 20 and an engagement assembly 30 engaging the clutch assembly 20. The engagement assembly 30 includes at least an active ring 33 and a corresponding passive ring 34. On interfacing faces of the active and passive rings 33 and 34, there are corresponding curved grooves 331 and 341 at equal distance, respectively, whose depth gradually reduces from end to end. Two balls 35 are housed and may be rolled in the grooves 331 and 341, respectively, so that, as the active ring 33 spins relative to the passive ring 34, the passive ring 34 shifts linearly towards or away from the active ring 33 and thereby the clutch assembly 20 connects or disconnects the driving and driven members 10 and 50.

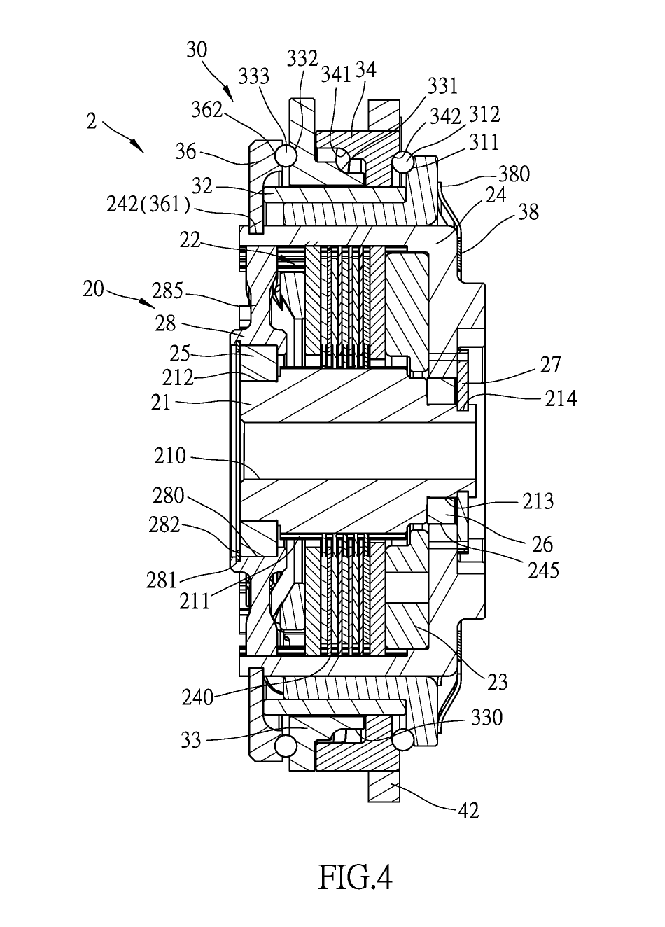

As shown in FIGS. 2, 3, and 4, the clutch assembly 20 includes at least a shaft 21, a lining set 22, a cap 24, and a support element 28. The shaft 21 has an axially end-to-end splined channel 210 meshing a toothed front section 15 of the driving member 10. As such, the driving member 10 may engage the shaft 21 into synchronous rotation. The outer circumference of the shaft 21 has axially extended teeth 211. The shaft 21 also has a front section 212 and a back section 213, both of a smaller diameter, for mounting the support element 28 and the cap 24 through a front antithrust bearing 25 and a back antithrust bearing 26, respectively. As such, the cap 24 and the support element 28 may spin relatively to the shaft 21. The lining set 22 includes a series of second discs 221 and a series of first discs 222 neighboring with the second discs 221. The first discs 222 have teeth along their inner rims locking with the teeth 211 of the shaft 21. The second discs 221 have teeth along their outer rims locking with splined inner wall 240 of the cap 24. When the second and first discs 221 and 222 are tightly attached together, the shaft 21 may engage the cap 24 synchronously. When the second and first discs 221 and 222 are not attached together, the shaft 21 cannot engage the cap 24. An elastic element 23 is positioned between the lining set 22 and a back wall of the cap 24 so that, when there is wear between the discs 221 and 222, the elastic element 23 compensates the wear automatically.

The cap 24 has a number of protrusions 241 at intervals along the cap 24's front opening, each with grooves 242 along outer circumference for fastening with an outer disc 36 of the engagement assembly 30. A number of pins 243 are configured on a back side of the cap 24 for connecting the driven member 50. The back side of the cap 24 has an opening 245 for the installation of the back antithrust bearing 26. The back section 213 of the shaft 21 has a limiting element 214 that may thread through the back antithrust bearing 26 and the cap 24, and fasten with two pieces 27. The cap 24 is therefore joined to the shaft 21. The ring-shaped support element 28 has a central opening 280 for the installation of the front antithrust bearing 25. The opening 280's inner wall has a groove 281 near its front rim for the installation of a ring 282 so as to confine the front antithrust bearing 25 on the support element 28. The support element 28 has a number of protrusions 285 radially extended from its circumference, each may be received by a notch 360 along an inner rim of the outer disc 36. Each protrusion 285 has a slot 286 on an outer end and, by fitting the support element 28 into the outer disc 36 and turning the support element 28, protrusions 361 between the notches 360 are plugged into the slots 286. As such, the support element 28 and the outer disc 36 are joined together and spin synchronously.

The engagement assembly 30 includes a drive member 31 which receives the cap 24. The drive member 31 has a ring flange 310 around a back side of the drive member 31. The ring flange 310 has a ring groove 311 along the rim of a front side of the ring flange 310. The drive member 31 further has an inward-bending, backward-pressing drive piece 315 against the lining set 22. Around the drive piece 315, there are a number of slots 316 for the protrusions 241 of the cap 24 to thread through. As such, the drive member 31 is able to move back and forth relative to the cap 24. The drive member 31 is surrounded by a ring sleeve 32 which is sandwiched between the active and passive rings 33 and 34. The active and passive rings 33 and 34 has interfacing ring faces 330 and 340 where the grooves 331 and 341 are formed respectively. Together with the ball 35, the active and passive rings 33 and 35 could be close to or away from each other when turned clockwise or counter-clockwise. The passive ring 34 has a ring groove 341 corresponding to the ring groove 311 of the flange 310, where, together, they allows two balls 312 to roll inside. The protrusions 241 of the cap 24 are plugged into the notches 360 of the outer disc 36. The engagement assembly 30 thereby is joined to the cap 24 of the clutch assembly 20 through the outer disc 36. There are also corresponding ring grooves 332 and 362 formed on the interfacing faces between the active ring 33 and the outer disc 36 where two balls 333 are accommodated to roll. An elastic ring 38 is fastened to the back side of the cap 24. The elastic ring 38 has a number of elastic pieces 380 radially extending from the circumference of the elastic ring 38 for pressing the back side of the drive member 31.

The engagement assembly 30 further includes a motor member 40 for turning the active ring 33. The motor member 40 includes a positioning ring 41 joined to the passive ring 34. The positioning ring 41 has a number of block 411 along its outer circumference, and at least a notch 410 along its inner circumference to match a block 345 on the outer circumference of the passive ring 34. The passive ring 34 therefore may move back and forth relative to the positioning ring 41. Also extending from the outer circumference of the positioning ring 41 is a positioning element 42 where a servo motor 45 is mounted. A gear 46 is mounted to the servo motor 45's shaft whose teeth mesh a toothed section 335 along the active ring 33's outer circumference. As such, the servo motor 45 may selectively engage the active ring 33 of the engagement assembly 30 to turn clockwise or counter-clockwise. As described above, a structurally simple, reliable, efficient, and enhanced driving clutch is achieved.

The operation of the present embodiment is as follows. As shown in FIGS. 2, 3, and 5, before the driving member 10 and the driven member 50 are coupled, the balls 35 are at the deepest locations of the grooves 331 and 341, respectively, and the drive member 31 pushes forward, causing the passive ring 34 to be closer to the active ring 33. The second and first discs 221 and 222 are not tightly attached and may turn separately. The shaft 21 that connects the driving member 10 and the cap 24 connecting the driven member 50 are not coupled. The driving member 10 therefore cannot engage the driven member 50.

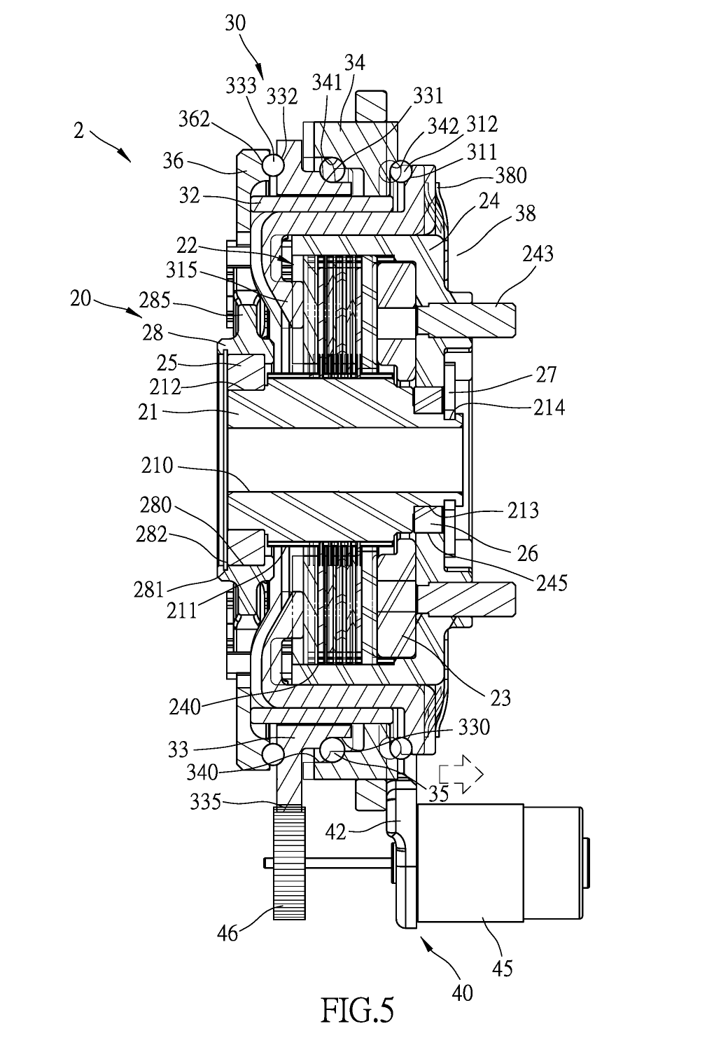

As shown in FIG. 5, to couple the driving and driven members 10 and 50, the servo motor 45 of the motor member 40, through its gear 46, turns the active ring 33 clockwise so that the balls 35 roll to the shallowest locations of the grooves 331 and 341. The passive ring 34 is moved backward to push the drive member 31 whose drive piece 315 synchronously causes the second and first discs 221 and 222 of the lining set 22 to attach tightly together. As such, the driving member 10 engages the driven member 50 through the shaft 21, the lining set 22, and the cap 24. When the serve motor 45 turns the active ring 33 counter-clockwise, as described above, the second and first discs 221 and 222 are restored to their un-attached condition, thereby decoupling the driving and driven members 10 and 50.

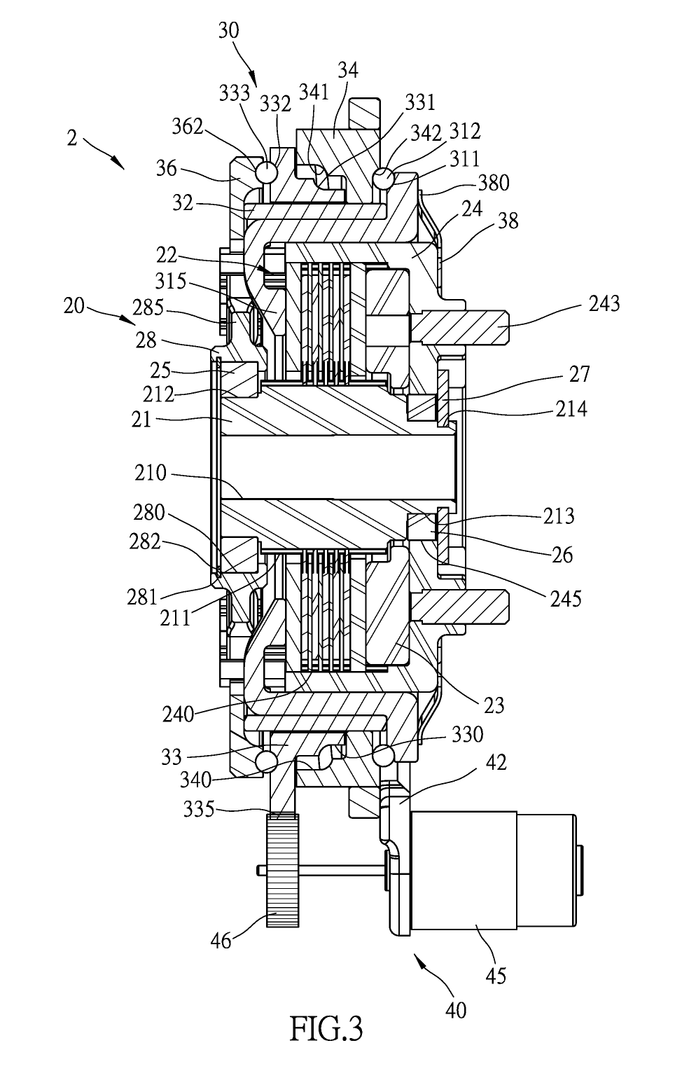

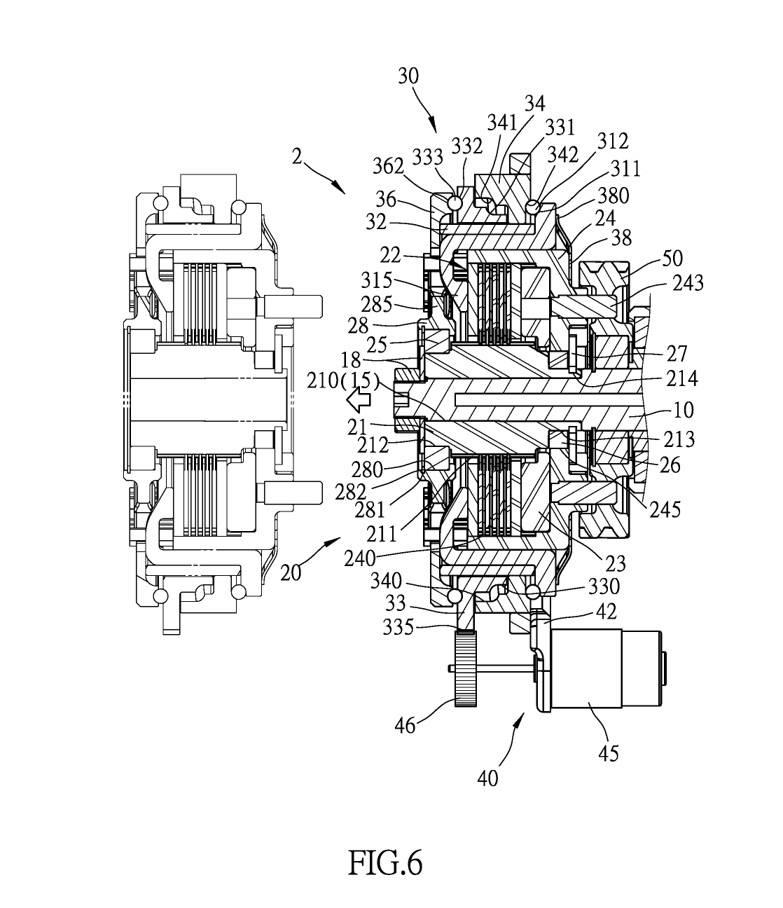

As shown in FIGS. 3 and 6, the clutch assembly 20 and the engagement assembly 30 jointly form an integral module through the back antithrust bearing 26, the pieces 27, the support element 28, the front antithrust bearing 25, the drive member 31, the elastic ring 38, and the outer disc 36. For replacement or maintenance, the clutch 2 may be detached from or assembled to the driving member 10 altogether simply and conveniently. The defected clutch 2 may be removed first and a new one is configured so that the apparatus may resume operation so that the defected clutch 2 is repaired without disrupting the operation of the apparatus.

The clutch 2 of the present embodiment utilizes the balls 35 between the active and passive rings 33 and 34 to operate the clutch assembly 20. The clutch 2 is therefore structurally simple, has a low failure rate, and may effectively reduce its form factor and production cost. Its function is purely through mechanical operation with limited triggering force but produce a powerful push. The lining set 22 of the clutch assembly 20 therefore may be quickly joined, thereby achieving greater reliability.

In the meantime, the elastic element 23 between the lining set 22 and the cap 24 provides an energy storage mechanism. When there is wear between the second and first discs 221 and 222 of the lining set 22, the elastic element 23 compensates the wear automatically without requiring complicated tuning to the servo motor, greatly enhancing the clutch's practicality.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A clutch configured between a driving member and a driven member, comprising a clutch assembly and an engagement assembly, wherein
the clutch assembly comprises a lining set which comprises a series of second discs coupled to the driven member and a neighboring series of first discs coupled to the driving member;
the engagement assembly configured to a side of the clutch assembly selectively attaching or separating the first and second discs of the lining set comprises an active ring and a corresponding passive ring, where corresponding curved grooves, whose depth gradually reduces from end to end, are formed on interfacing faces of the active and passive rings, and two balls are housed in the grooved, respectively; and
as the active ring spins relative to the passive ring, the balls roll along the grooves between shallowest and deepest locations, the passive ring shifts linearly away from or towards the active ring and thereby the first and second discs are selectively attached to or separated from each other.

2. The clutch according to claim 1, wherein the clutch assembly further comprises an elastic element disposed to a side of and compressed by the lining set for compensating wear between the first and second discs.

3. A clutch configured between a driving member and a driven member, comprising a clutch assembly and an engagement assembly, wherein the clutch assembly comprises a shaft, a lining set, a cap, and a support element;
the shaft selectively coupled to the driving member;
the support element and the cap joined to two ends of the shaft, respectively;
a lining set which comprises a series of first discs coupled to the shaft and a neighboring series of second discs coupled to the cap;
the cap has a plurality of protrusions at intervals along the cap's front opening;
the engagement assembly configured to a side of the clutch assembly selectively attaching or separating the first and second discs of the lining set;
the engagement assembly comprises a drive member which receives the cap, where the drive member has a ring flange around a back side of the drive member, and an inward-bending, backward-pressing drive piece against the lining set having a plurality of slots for the protrusions of the cap to thread through;
the engagement assembly further comprises an elastic ring fastened to a back side of the cap for pressing the back side of the drive member, an outer disc fastened to the protrusions, an active ring and a corresponding passive ring between the drive piece and the outer disc, where corresponding curved grooves, whose depth gradually reduces from end to end, are formed on interfacing faces of the active and passive rings, and two balls are housed in the grooved, respectively;
as the active ring spins relative to the passive ring, the balls roll along the grooves between shallowest and deepest locations, the passive ring shifts linearly away from or towards the active ring and thereby the first and second discs are selectively attached to or separated from each other by the drive piece.

4. The clutch according to claim 3, wherein the shaft has an axially end-to-end splined channel meshing a toothed front section of the driving member, and teeth axially extended from an outer circumference of the shaft; the cap has a splined inner wall; the first discs have teeth along their inner rims locking with the teeth of the shaft; and the second discs have teeth along their outer rims locking with splined inner wall of the cap.

5. The clutch according to claim 3, wherein the shaft has a front section and a back section, both of a smaller diameter, for mounting the support element and the cap through a front antithrust bearing and a back antithrust bearing, respectively; the back side of the cap has an opening for the installation of the back antithrust bearing; the back section of the shaft has a limiting element threading through the back antithrust bearing and the cap, and fastening with two pieces; the support element has a central opening for the installation of the front antithrust bearing; and the opening's inner wall has a groove near its front rim for the installation of a ring so as to confine the front antithrust bearing on the support element.

6. The clutch according to claim 3, wherein the clutch assembly further comprises an elastic element disposed to a side of and compressed by the lining set for compensating wear between the first and second discs.

7. The clutch according to claim 3, wherein engagement assembly further comprises a ring sleeve surrounding the drive member and sandwiched between the active and passive rings.

8. The clutch according to claim 3, wherein corresponding ring grooves are formed on a rim of a front side of the ring flange and the passive ring where two balls are accommodated to roll, respectively; and corresponding ring grooves are formed on the interfacing faces between the active ring and the outer disc where two balls are accommodated to roll.

9. The clutch according to claim 3, wherein the outer disc is ring shaped with a plurality of notches and protrusion alternately configured along an inner rim of the outer disc; each protrusion has grooves along outer circumference for fastening with the outer disc so that the engagement assembly is joined to the cap through the outer disc.

10. The clutch according to claim 9, wherein the support element's circumference has a plurality of radially extending protrusions, each having a slot on an outer end for locking the support element and the outer disc together so that the outer disc and the support element spin synchronously.

11. The clutch according to claim 3, wherein the engagement assembly further comprises a motor member for turning the active ring; the motor member comprises a positioning ring joined to the passive ring, a servo motor mounted to the positioning ring, and a gear mounted to the servo motor's shaft whose teeth mesh a toothed section along the active ring's outer circumference; and the servo motor selectively engage the active ring to turn clockwise or counter-clockwise.

12. A clutch configured between a driving member and a driven member, comprising a clutch assembly and an engagement assembly, wherein
the clutch assembly comprises a shaft, a lining set, a cap, and a support element;
the shaft selectively coupled to the driving member;
a lining set which comprises a series of first discs coupled to the shaft and a neighboring series of second discs coupled to the cap;
the cap has a plurality of protrusions at intervals along the cap's front opening;
the shaft's front and back ends join the support element and the cap through a front antithrust bearing and a back antithrust bearing, respectively;
the back end of the shaft has a limiting element threading through the back antithrust bearing and the cap, and fastening with two pieces;
the support element has a central opening for the installation of the front antithrust bearing;
the opening's inner wall has a groove near its front rim for the installation of a ring so as to confine the front antithrust bearing on the support element;
the engagement assembly configured to a side of the clutch assembly selectively attaching or separating the first and second discs of the lining set;
the engagement assembly comprises a drive member which receives the cap, where the drive member has a ring flange around a back side of the drive member, and an inward-bending, backward-pressing drive piece against the lining set having a plurality of slots for the protrusions of the cap to thread through; and
the engagement assembly further comprises an elastic ring fastened to a back side of the cap for pressing the back side of the drive member, an outer disc fastened to the protrusions of the cap, an active ring and a corresponding passive ring between the drive piece and the outer disc, where corresponding curved grooves, whose depth gradually reduces from end to end, are formed on interfacing faces of the active and passive rings, and two balls are housed in the grooved, respectively.

13. The clutch according to claim 12, wherein the shaft has an axially end-to-end splined channel meshing a toothed front section of the driving member, and teeth axially extended from an outer circumference of the shaft; the cap has a splined inner wall; the first discs have teeth along their inner rims locking with the teeth of the shaft; and the second discs have teeth along their outer rims locking with splined inner wall of the cap.

14. The clutch according to claim 12, wherein the clutch assembly further comprises an elastic element disposed to a side of and compressed by the lining set for compensating wear between the first and second discs.

15. The clutch according to claim 12, wherein engagement assembly further comprises a ring sleeve surrounding the drive member and sandwiched between the active and passive rings.

16. The clutch according to claim 12, wherein corresponding ring grooves are formed on a rim of a front side of the ring flange and the passive ring where two balls are accommodated to roll, respectively; and corresponding ring grooves are formed on the interfacing faces between the active ring and the outer disc where two balls are accommodated to roll.

17. The clutch according to claim 12, wherein the outer disc is ring shaped with a plurality of notches and protrusion alternately configured along an inner rim of the outer disc; each protrusion has grooves along outer circumference for fastening with the outer disc so that the engagement assembly is joined to the cap through the outer disc.

18. The clutch according to claim 17, wherein the support element's circumference has a plurality of radially extending protrusions, each having a slot on an outer end for locking the support element and the outer disc together so that the outer disc and the support element spin synchronously.

19. The clutch according to claim 12, wherein the engagement assembly further comprises a motor member for turning the active ring; the motor member comprises a positioning ring joined to the passive ring, a servo motor 45 mounted to the positioning ring, and a gear mounted to the servo motor's shaft whose teeth mesh a toothed section along the active ring's outer circumference; the servo motor selectively engage the active ring to turn clockwise or counter-clockwise.

20. The clutch according to claim 4, wherein the shaft has a front section and a back section, both of a smaller diameter, for mounting the support element and the cap through a front antithrust bearing and a back antithrust bearing, respectively; the back side of the cap has an opening for the installation of the back antithrust bearing; the back section of the shaft has a limiting element threading through the back antithrust bearing and the cap, and fastening with two pieces; the support element has a central opening for the installation of the front antithrust bearing; and the opening's inner wall has a groove near its front rim for the installation of a ring so as to confine the front antithrust bearing on the support element.

21. The clutch according to claim 7, wherein corresponding ring grooves are formed on a rim of a front side of the ring flange and the passive ring where two balls are accommodated to roll, respectively; and corresponding ring grooves are formed on the interfacing faces between the active ring and the outer disc where two balls are accommodated to roll.

22. The clutch according to claim 15, wherein corresponding ring grooves are formed on a rim of a front side of the ring flange and the passive ring where two balls are accommodated to roll, respectively; and corresponding ring grooves are formed on the interfacing faces between the active ring and the outer disc where two balls are accommodated to roll.
